(19) United States
(12) Patent Application Publication
(10) Pub. No.: US 2009/0191509 A1
(43) Pub. Date: Jul. 30, 2009

(54) PROCESS FOR REGISTERING DENTAL MODELS

(76) Inventors: Gerhard Züdorf, Bonn (DE); Erwin Keeve, Bonn (DE); Lutz Ritter, Bornheim (DE); Dirk Freyer, Kola (DE); Nils Hanssen, Bonn (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/064,717

(22) PCT Filed: Aug. 25, 2006
(86) PCT No.: PCT/EP2006/008365

§ 371 Date: Aug. 25, 2008

(30) Foreign Application Priority Data
Aug. 26, 2005 (DE) 10 2005 040 740.4

(51) Int. Cl. A61C 11/00

(52) U.S. Cl. 433/213

(57) ABSTRACT

Process for planning an operational intervention on a body part, in particular on the jaw, of a patient, whereby within the framework of a recording, a common reference system is defined between a set of patient data that are registering with a recording device and that show the body part in its three-dimensionality, and a model of the body part, whereby the patient is held in place, during the registering of the patient data, with the body part in a securing device (3), which is brought into a defined position relative to the registering device, whereby after registering the patient data, the model (7) is positioned by means of a holding device (8) in a corresponding location in the securing device (3), whereby the holding device (8) is in a defined position relative to the securing device (3), whereby the model (7) in this defined position is secured to the holding device (8) and whereby additional planning steps are undertaken on the model (7) that is secured on the holding device (8).

This invention relates to, on the one hand, a process for planning an operational intervention on a body part, in particular on the jaw, of a patient, whereby within the framework of a registering, a common reference system is defined between a set of patient data that are produced with, particularly, a tomographic registering device and that show the body part in its three-dimensionality, and a model of the body part, whereby during the registering of the patient data, the patient is held in place with the body part in a securing device, which is brought into a defined position relative to the registering device. The invention relates, as it were, to a system for implementing such a process. In addition, the invention relates to a process for producing and registering patient data from a body part, in particular the jaw, of a patient, that is picked up with a registering device in a time series, whereby during the registering of the patient data, the patient is held in place with the body part in a securing device, which is mounted in a defined position relative to the registering device.

For the planning of operational interventions specifically in the jaw area, image data of the patient are prepared in the preoperational phase by means of computer tomography (CT), cone-beam technology or nuclear spin tomography (NMR) so as to be able to include the generated volume data sets in the computer-supported planning of the later operations. The interpretation and use of the patient data in this case, however, are frequently hampered by metal artifacts, which result from dental fillings.

To produce the operations plans that are generated based on the computer data, templates are used whose positioning in the reference system of the patient data and in the reference system of the patient himself have to be identical. To achieve the correspondence, the templates are registering relative to the patient. To this end, the patient's “real world” coordinates are made to coincide with the world of the corresponding data sets and the planning based thereon.

The templates themselves are in most cases constructed based on dental models, whereby the dental models also have to be registering relative to the patient data. To this end, the following processes, of course, are used:

On the one hand, it is known that the registering can be performed by means of radio-opaque labels, which can be detected both optically and in the 3D x-ray data set. These labels have to be inserted into an oral appliance that is to be produced before the registering and that is worn by the patient during the scan. In this case, the radio-opaque labels form a reference system that is associated in a defined geometric manner with mechanical interfaces, patients, or even tools to be machined. In the thus defined reference system, the computer-planned operations plans can be produced. The problem of this technology lies in, on the one hand, an individual oral appliance having to be created. Moreover, special markers are required.

It is also known to perform the registering by computer by matching the surfaces. To this end, the surfaces of the teeth are determined from the patient data, on the one hand, and from the data sets of the dental model, on the other hand. Then, the surfaces are placed on another by means of a registering algorithm, such that the two data sets correspond. It is disadvantageous that this process is susceptible to interference, since a complete correspondence of the surfaces is not possible. This primarily applies if the quality of the registering of the patient is impaired by metal artifacts.

In this case, the images of the dental model can be produced optically, for example, with a laser scan, and can be registering with the corresponding data set of the patient, which is produced by means of x-ray imaging. Up until now, two devices have been necessary, which is accompanied by a high cost in terms of equipment.

DE 197 25 197 A1 shows a system in which during a registering, the patient is secured with reference elements in the form of earplugs, whereby labeling arms form a coordinate system. By means of a bite fork, on which the patient bites down, the plaster model of the jaw can be held in the articulator in the corresponding position relative to the imaging plane (Camper's plane).

The object of the invention is now to provide a process and a system that can be produced economically with simple means and that makes possible a precise registering between the volume image data picked up on a patient and a model of the corresponding body part of the patient while being simple to handle and suitable for practice. Moreover, it is the object of the invention to provide a process for simple and reliable registering of control images.

These objects are achieved with the process according to claim 1, the system according to claim 7, and the process according to claim 12. Advantageous embodiments of the invention are mentioned in the respective subclaims.

The essential idea of the invention is in a registering that employs exclusively mechanical means, in particular a universal mechanical interface that is normalized for all devices necessary for planning and production, such as the tomographical registering device and the drilling and grinding device. This is possible in that the reference system is defined only via a securing device that holds the patient and the model in the same position. The latter defines the invariant location of the patient and forms the reference system without an external reference system being required. For securing the model in the same position, a holding device that holds the model in the securing device is provided.

In this case, according to the registering of patient data by means of the holding device, which is in a defined position relative to the security device, the model is first positioned on the securing device in the corresponding location, before it is secured together with the holding device. Holding device and model then form a unit that is in a fixed reference to the securing device. Additional steps required within the framework of the planning can then be performed on this unit.

In this case, it is not necessary that the positioning of the model via the holding device takes place on the securing device that is held in the registering device. It is advantageous, however, when the securing device is first removed from the position on the registering device and is attached to a stand that is independent from the registering device and that can be found in a laboratory. In this state, the model is then positioned and secured by means of the holding device. Since the holding device is in a defined position in the securing device, its position is also known relative to the registering device and thus relative to the patient data. Optionally, the model that is secured in the holding device can then be positioned for a scan in the registering device, whereby the holding device, as is described below, is held in particular by means of an adapter ideally in a corresponding registering on the registering device.

A special advantage of the invention lies in the fact that with the process that is presented, the registering between dental model and patient data can be carried out with the same registering device, in which the patient and the model are kept in the same position. Another device, such as, for example, a laser scanner, is not necessary. Using the invention, in addition, an exact visualization of the teeth is possible, which can be used as a basis for computer-supported planning systems. Thus, the occlusion, i.e., the actual spatial positional relationships of the teeth to one another, can also be included.

The mechanical registering according to the invention can be used as a basis for the application to CAD/CAM techniques in the tooth model that are known in the art, with which templates for intraoperational use are produced. In contrast, the dental model that is registering according to the invention offers a visualization with accurate details of the anatomy of the patient with the occlusion thereof. Altogether, a number of possibilities for image processing are produced from the presence of the complementary sets of data. Additional advantages of the invention lie in the reduced radiation exposure of the patient and in the high accuracy of the registering. Since the dental model can be recorded with the same device as the patient, advantages are created in logistics and a cost reduction because of the reduction of cost in terms of equipment. The invention therefore increases the appeal for the production of templates, which reduces the risk for patients during interventions.

It is especially advantageous if, during the registering, a bite guard with, in particular, a horseshoe-shaped bite surface is used as a securing device. The bite guard can be part of the registering device, which advantageously has a mechanical interface for securing, in which the bite guard optionally is inserted by means of a corresponding adapter and is thus secured in a removable manner. In the registering, the removable bite guard is secured relative to the imaging device via the adapter in a defined position. In the conversion of the process, the bite surface is now coated from above and/or from below with quick-hardening impression material, on which the patient bites and which then hardens within a short time. The patient, who is secured via the bite guard in a defined position relative to the imaging registering device, can now be scanned.

According to the invention, the bite guard for producing a registering set of data of the dental model is allowed to be secured together with the hardened compression material to the registering device, while the dental model is inserted in the impression material. Since the patient and dental model have the same structures, the dental model fits exactly into the impression material and thus is in the position of the patient's teeth in the 3D volume data set. Then, the securing device can be removed, and a registering of the dental model can be produced with the registering device. The advantage of the registering of the dental model lies in the fact that the image data of the dental model are not affected by artifacts, since no metallic objects generated by such artifacts are found in the dental model. Since no radiation protection is necessary for the dental model, the high-dosed radiation can be picked up and as a result, an optimal image quality can be achieved. The dental model and the teeth of the patient are found in both images at exactly the same position relative to the registering device and are thus registering. By image processing, for example, the two data sets can be melted together such that the high-resolution artifact-free registering of the teeth is taken, if necessary, instead of the poorer registering of the patient's actual teeth. In this case, the image data of the patient and the model can be superimposed by computer without transforming the reference system.

In further computer-supported or manual processing of the dental model, other planning steps can also be undertaken in the model that is secured to the holding device. Thus, the model that is secured to the holding device can be removed and clamped in the receiving part of a processing device, in particular a drilling, sawing and/or grinding device. In this case, the registering of the processing device is in a defined reference relative to the securing device via the specified geometric relationships.

To avoid a coordinate transformation, the securing device and the holding device can use the same mechanical interface. It is not essential, however, to provide expensive, different interfaces that, as stated, are in a defined geometric reference relative to one another. In the thus registering dental model, the steps of the operational intervention, in particular the introduction of a drilling channel and the adaptation of an implant, can be simulated by taking the image data of the patient as a basis.

High-grade visualizations of the mouth, jaw and face regions can be produced with the invention. In particular, a number of advantages in the area of image-processing technology result with the patient's known positioning in the data set and the artifact-free visualization of the teeth as well as the mucous membrane. Optimal requirements for still more specific registering processes based on images are provided by the mechanical registering, since now an optimal starting point is defined.

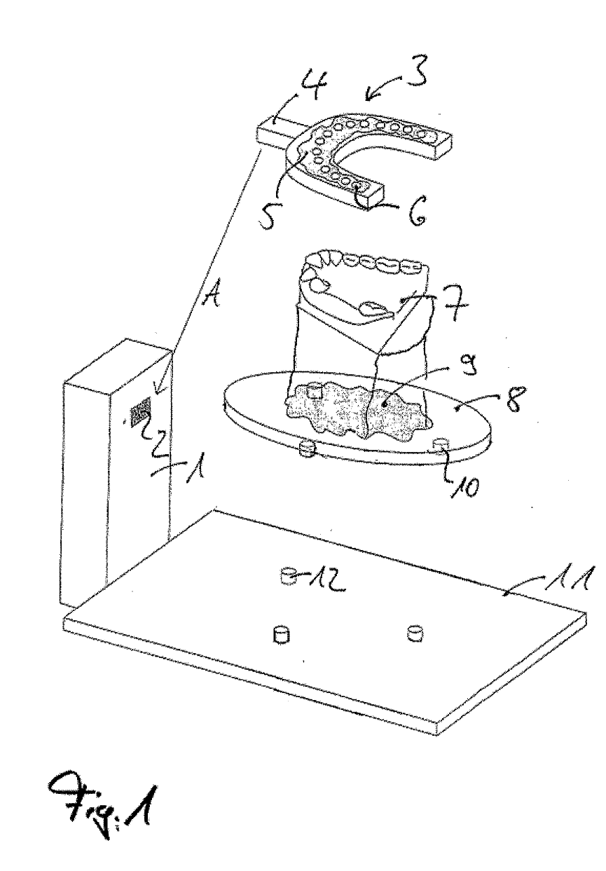

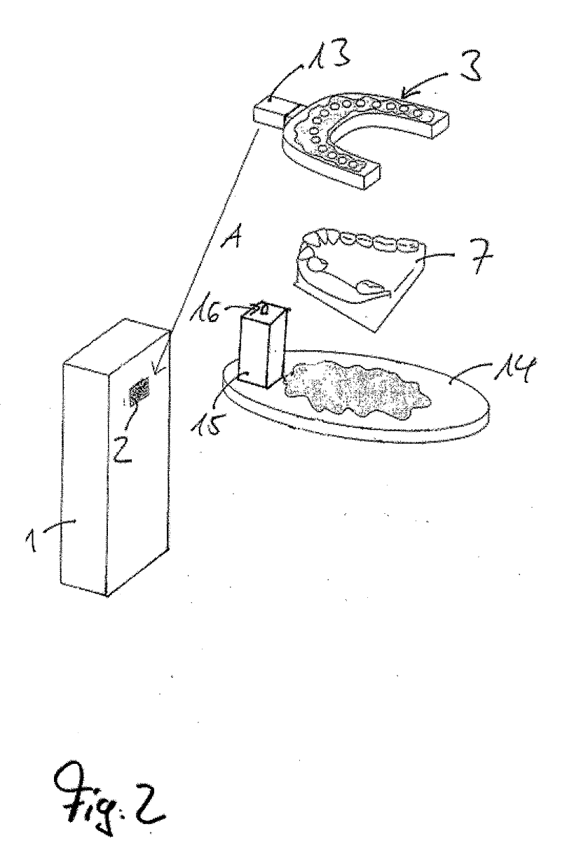

Below, the invention is explained in more detail based on FIGS. 1 and 2. Here:

FIG. 1 shows a device for registering with two interfaces, and

FIG. 2 shows a device for registering with one interface.

In FIG. 1, a stand 1 is shown as it can be set up in the laboratory of a dental technician. A receiving box 2 that is designed as an interface, in which a bite guard 3 can be inserted as a securing device by means of a connecting element 4 attached thereto, is provided in the stand 1 (Arrow A). The bite guard 3 is coated with bite material 5 that has hardened in the meantime, into which a patient had bitten and had left behind his dental impressions 6. The latter are also present on the bottom but are not shown. While the patient had clamped the bite guard 3 between his teeth, patient data thereof were produced with a scan, whereby the bite guard 3 was inserted for this purpose into a corresponding box of the registering device, in particular the cone beam device.

After production of the patient data, which show the jaw in its three-dimensionality, the bite guard 3 is transported to the stand 1, and a dental model 7 of the patient is inserted from below into the bite guard 3. For holding the dental model 7, in this case a seat 8 is provided, on which the dental model 7 is glued by means of a high-building adhesive 9, e.g., plaster. The seat 8 of the same is mounted on a base plate 11 (arrow B) and held in place via securing pins 10 and corresponding holes 12. The dental model is held in exact position in the bite guard 3 via the adhesive 9, whereby the seat 8 and the base plate 11 are in a defined orientation relative to the stand 1. In this case, the base plate 11 is fastened to the stand 1.

Such a base plate 11, in particular the same, can be attached to the registering device in the corresponding position. After the dental model 7 is attached by means of the seat 8, a scan of the dental model 7 can be produced that, in purely mechanical terms, is in the same position as the patient was before.

In addition, the seat 8 that is used as a holding device can be removed from the registering device and can also be clamped via the securing pins 10 in a device in a defined way for further processing. In this case, the seat 11 that is attached to the base plate 11 is used as a fastening means, which makes possible a securing of the model in the securing device and which ensures that the model is held in this position after the securing device is removed.

The base plate 11 thus has a defined mechanical interface on its top side with the holes 12. In this case, the geometric relationship of the mechanical interface on the top side of the base plate and the stand 1 is defined and known for the bite guard. Thus, the exact positioning of the seat 8 is possible. An embodiment of the transfer device is also conceivable, in which the holding device for the bite guard is mounted to move to facilitate the plaster-fixation process. Another embodiment is conceivable in which a seat is attached in addition above the bite guard, so that both upper jaw and lower jaw can be transferred in a single process.

Also, in FIG. 2, such a stand 1 that is in a defined position in the registering device and that has a receiving box 2 designed as an interface 2 is shown. In this case, it provides a universal adapter 13 as a connecting element, to which the bite guard 3 is fastened in a removable manner and via which it can be inserted into the receiving box 2. During the registering of the patient data, the bite guard 3 was held via a corresponding receiving box 2 on the registering device. As in the preceding embodiment the bite guard 3 remains on the stand 1 until the dental model 7 is inserted from below and secured.

In this embodiment, the seat 14 is attached directly to the adapter 13 via a support arm 15, however. To this end, a connector 16 is provided. After the seat 14 is installed on the adapter 13, the dental model 7 is secured on the bite guard 3 again by means of a support formed on a building adhesive 9 in the specified position. Now, a scan is produced by the dental model 7, which is found in the same position of the patient as before based on the purely mechanical means according to the invention. The seat 14 can also be removed again from the registering device and also can be clamped via the adapter 13 to a device for additional processing. In this embodiment, a universal interface is achieved with the adapter 13 and the receiving box 2, with which all requirements as regards registering in the environment of the preoperational planning can be met.

According to the invention, in both embodiments, the model is positioned after the registering of the patient data by means of a holding device in a corresponding location in the securing device, whereby the holding device is in a defined orientation relative to the securing device. The model is then secured to the holding device via the support in this location, such that additional planning steps on the model that is secured to the holding device can be undertaken.

Below, the individual steps of the registering are listed once again:
1. Production of a dental model for the patient to be scanned by means of conventional technology.
2. Coating of a bite guard with quick-hardening impression material, e.g., silicone.
3. The patients can bite on the coated bite guard and impression material can harden.
4. Scanning of the patient secured on the bite guard with, e.g., an x-ray scanner.
5. Positioning and securing of the dental model on the bite guard.
6. Scanning of the dental model with the same x-ray scanner.
7. Superimposing the patient's scan on the dental model (“registering”).
With the registering of the dental model relative to the radiological set of data of a patient,
   a number of applications are now possible, which are shown below:
   Production of a drilling template:
1. Removal of the bite guard and the dental model from the registering device.
2. Transferring the registering by means of the above-described device on two seats, on which in each case the models for the upper and lower jaws are secured. The seats have a definitive mechanical interface whose geometric relationship to the image of the bite guard is known and defined.
3. Positioning of the dental model by means of the seat on a drilling and/or grinding device. As a result, the registering is transferred.
4. Manual production of the drilling template according to known dentistry processes based on the dental model.
5. Planning of the holes to be drilled, incisions, threads, osteotomies or other surgical interventions in the registering set of patient and dental model data.
6. Transferring the planning to the CNC machine or output of the planning data for the adjustment of drilling or grinding devices to be operated manually.
7. Computer-controlled drilling or grinding by a CNC machine in the drilling template or manual drilling/grinding according to planning data.

Drilling templates for implantology and the placing of distractors or mini-plates can be produced. In addition, by grinding a surface on the templates secured to the teeth, interfaces and/or sawing surfaces can be prepared, which guide the respective surgical instrument.

The above-described securing device that is designed in particular as a bite guard is useful not only within the framework of the process depicted, in which an operational intervention is planned based on a body part of the patient and a model of the body part. Those securing devices that are provided with hardened impression material and thus are matched individually to the patients can also be used in processes for producing and registering patient data that is recorded in a time series with a registering device, showing in particular a body part in its three-dimensionality. To this end, during the registering of the patient data, the patient is held with the corresponding body part in the securing device, which is attached in a defined position relative to the registering device. The special advantage lies in the fact that the patient is tightly secured in the registering space of the registering device in a reproducible way.

According to the invention, the securing device is coated with an impression material before the body part of the patient is pressed into the impression material, and the impression material is hardened. Then, the first patient data are recorded. At a later time, another registering of the patient positioned with the same body part in the hardened impression material is prepared. The thus prepared data sets of successive images can be compared to one another, in particular by computer, without further coordinate transformation. In this case, it is especially advantageous it in particular, a horseshoe-shaped bite guard, which is coated with impression material, is used as a securing device.

The securing device, in particular the bite guard, can thus be used to secure patients and to register images of the patient which were made at various times. This registering of a time series of images is in this case possible by the positioning, reproducible to a great extent, of the patient who is held by the bite guard in the registering device. This simple process is useful in particular for the monitoring of the course of diseases and for the monitoring of the success.

As shown, in this procedure, the constancy of the mechanical interfaces in the device as well as the reproducible positioning of the patient in the securing device are the most important requirements. According to the invention, the body part, in particular the jaw (upper or lower jaw) is selected as an anatomical structure of relatively constant form and with suitable geometric and biomechanical properties for taking impressions. In contrast, an impression material that is dimensionally stable as well over extended periods and that has a suitable elasticity in the case of undercutting is used. Since an almost unlimited number of images distributed over extended periods are possible with such a securing device that is coated with impression material, it should be possible to disinfect the securing device.

The procedure according to the invention for preparing a first image can take place in the following steps:
1. Coating a securing device, in particular in the form of a horseshoe-shaped bite guard, with hardening impression material.
2. Taking impressions on a patient.
3. Installing the securing device on the imaging device by means of a defined interface.
4. Positioning of the patient in his previously prepared impression.
5. Performing a scan.
6. Releasing the patient from the impression material.
7. Removing the securing device.

The control image can take place in the following steps.
1. Installing the securing device, already provided with an individual patient impression, on the imaging device by means of a defined interface.
2. Positioning the patient in his previously prepared impression.
3. Performing a scan.
4. Releasing the patient from the impression material.
5. Removing the securing device.

1. Process for planning an operational intervention on a body, especially on the jaw, of a patient, whereby within the framework of a registering, a common reference system is defined between a set of patient data that are recorded with a registering device and that show the body part in its three-dimensionality, and a model of the body part, whereby the patient is held in place during the registering of the patient data with the body part in a securing device (3), which is brought into a defined position relative to the registering device, characterized in that after registering the patient data, the model (7) is positioned by means of a holding device (8) in a corresponding location in the securing device (3), whereby the holding device (8) is in a defined position relative to the securing device (3), in that the model (7) in this defined position is secured to the holding device (8), and in that additional planning steps are undertaken on the model (7) that is secured on the holding device (8).

2. Process according to claim 1, wherein the securing device (3) is removed from the position on the registering device and is held in place on a stand (1) that is independent of the registering device before the model (7) is positioned and secured by means of the holding device (8).

3. Process according to claim 1, wherein in an additional planning step, the securing device (3) is removed, and a registering of the model (7) is prepared with the registering device, whereby the model (7) is found in the same defined position of the patient as before and whereby the image data of the patient and the model (7) are superimposed by computer without transformation of the reference system.

4. Process according to claim 1, wherein in an additional planning step, the model (7) that is secured on the holding device (8) is removed together with the holding device (8) and is clamped in the receiving part of a processing device, in particular a drilling and/or grinding device, whereby the registering is in a defined reference relative to the securing device (3).

5. Process according to claim 4, wherein steps of the operational intervention, in particular the introduction of a drilling channel and the adaptation of an implant, can be simulated in the model by taking the image data of the patient as a basis.

6. Process according to claim 1, wherein a bite guard (3) with impression material (5), which is hardened in the bite of the patient, is used as a securing device.

7. System for defining a common reference system (“registering”) that has a tomographic registering device for registering a set of patient data and that has a securing device (3) for the defined positioning of the patient during the registering and that has a model (7) of the patient's body part, in particular the jaw, that is to be recorded, wherein the securing device (3) has a mechanical interface (4) by which it can be attached in a removable way to the registering device in a defined position, and wherein a fastening means (8, 11) is present that makes possible a securing of the model (7) in the securing device (3) and wherein holding the model (7) in this position after removing the securing device (3) is ensured.

8. System according to claim 7, wherein the fastening means (8, 11) has a mechanical interface (4, 13), with which it is held in a defined position on the registering device.

9. System according to claim 8, wherein the fastening means (8, 11) can be held in a defined position via the mechanical interface on a processing device, in particular a CNC machine/drilling-grinding unit.

10. System according to claim 7, wherein the securing device is a bite guard (3).

11. System according to claim 10, wherein the bite guard and/or the fastening means can be held in a removable manner via an adapter (13) on the registering device or the processing device in a defined position.

12. Process for production and registering of imaged, in particular three-dimensional, patient data of a body part, in particular a jaw, of a patient, in a time series with a registering device, whereby during the registering of the patient data, the patient is held in place with the body part in a securing device (3), which is attached in a defined position relative to the registering device, wherein the securing device (3) is coated with an impression material (5), wherein the body part of the patient is pressed into the impression material and the impression material (5) is hardened, and wherein the first patient data are recorded, wherein at a later time, another registering of the patient positioned with the body part in the hardened impression material (5) is produced, and wherein the sets of data of the successive images are compared to one another.

13. Process according to claim 12, wherein in particular, a horseshoe-shaped bite guard (3), which is coated with impression material (5), is used as a securing device.
